(19) United States
(12) Patent Application Publication
(10) Pub. No.: US 2022/0108318 A1
(43) Pub. Date: Apr. 7, 2022

(54) QUANTUM COMPUTING BASED REAL-TIME VERIFICATION SYSTEM

(71) Applicant: Bank of America Corporation, Charlotte, NC (US)

(72) Inventors: Suki Ramasamy, Chennai (IN); Thilaga Kannappan, Chennai (IN); Deve Madhavan Nair, Chennai (IN); Vishnurupa N R, Thanjavur (IN); Suganya Markandan, Tamil Nadu (IN); Anusha Balasubramanian, Chennai (IN); Kalpana Rajashekar, Chennai (IN)

(21) Appl. No.: 17/060,156

(22) Filed: Oct. 1, 2020

(51) Int. Cl. G06Q 20/40; G06N 10/00; G06Q 20/36; G06K 9/62; G06N 20/00

(52) U.S. Cl. CPC G06Q 20/4016; G06N 10/00; G06N 20/00; G06Q 20/405; G06K 9/6256; G06Q 20/3674

(57) ABSTRACT

Aspects of the disclosure relate to quantum computing based real-time verification system. A computing platform may receive one or more features of a transaction by a customer, and retrieve, from a plurality of data sources, one or more attributes that may impact the transaction. Then, the computing platform may identify a plurality of business rules applicable to the transaction. Then, the computing platform may transform, based on the one or more features of the transaction, the one or more attributes that may impact the transaction, and the plurality of business rules applicable to the transaction, the transaction to sequence of quantum bits. Subsequently, the computing platform may determine a risk score for the sequence of quantum bits. Then, the computing platform may determine whether the transaction is valid, and provide an alert to the transaction processing platform.

### BACKGROUND

Aspects of the disclosure relate to deploying digital data processing systems to identify and detect potentially unauthorized activity in real-time. In particular, one or more aspects of the disclosure relate to quantum computing based real-time verification systems.

Enterprise organizations may use various transaction processing platforms to support customer transactions. Such transactions may include a complex array of attributes, and multiple factors that may impact the transactions. In some instances, the transactions may need to be processed to ensure validity, and prevent unauthorized use of, and access to, enterprise resources. Ensuring that factors impacting a transaction are properly identified, timely and targeted evaluations of the transactions are performed, may be highly advantageous to maintain efficient and stable transaction processing platforms. In many instances, however, it may be difficult to perform evaluations of the transactions with speed and accuracy by using classical computing, while also attempting to optimize network resources, bandwidth utilization, and efficient operations of the computing infrastructure.

### SUMMARY

Aspects of the disclosure provide effective, efficient, scalable, fast, reliable, and convenient technical solutions that address and overcome the technical problems associated with quantum computing based real-time verification system.

In accordance with one or more embodiments, a computing platform having at least one processor, and memory storing computer-readable instructions that, when executed by the at least one processor, cause the computing platform to receive, by a computing device and from a transaction processing platform, one or more features of a transaction by a customer. Subsequently, the computing platform may retrieve, by the computing device and from a plurality of data sources, one or more attributes that may impact the transaction. Then, the computing platform may identify, by the computing device and based on the transaction and the one or more attributes, a plurality of business rules applicable to the transaction. Then, the computing platform may transform, by the computing device and based on the one or more features of the transaction, the one or more attributes that may impact the transaction, and the plurality of business rules applicable to the transaction, the transaction to a sequence of quantum bits. Subsequently, the computing platform may determine, by the computing device and for the sequence of quantum bits, a risk score indicative of a validity of the transaction. Then, the computing platform may determine, by the computing device and based on the risk score, whether the transaction is valid. Then, the computing platform may provide, by the computing device and based on a determination that the transaction is not valid, an alert to the transaction processing platform.

In some embodiments, the computing platform may receive, by the computing device and from the transaction processing platform, one or more features of a second transaction by the customer. Then, the computing platform may transform, by the computing device and based on one or more features of the second transaction, one or more attributes that may impact the second transaction, and a plurality of business rules applicable to the second transaction, the second transaction to a second sequence of quantum bits. Subsequently, the computing platform may match, based on a repository of historical transactions, the second sequence of quantum bits to the sequence of quantum bits. Then, the computing platform may associate, based on the matching, the risk score with the second sequence of quantum bits. Then, the computing platform may determine, based on the determination that the transaction is not valid, that the second transaction is not valid. Subsequently, the computing platform may provide, to the transaction processing platform, a second alert that the second transaction is not valid.

In some embodiments, the risk score may be a value between 0 and 1, and where 1 may be indicative of a high likelihood that the transaction is not valid, and where 0 may be indicative of a high likelihood that the transaction is valid.

In some embodiments, the computing platform may determine the risk score by determining, for the sequence of quantum bits, a plurality of risk scores, and identifying a particular risk score, of the plurality of risk scores, that has a high probability of occurrence.

In some embodiments, the computing platform may determine whether the transaction is valid by comparing the risk score to a threshold, and determining that the transaction is not valid when the risk score is above the threshold.

In some embodiments, the computing platform may determine whether the transaction is valid by determining that the risk score is within a range of ambiguity, providing an alert to a compliance personnel to determine the validity of the transaction, receiving, via the computing device and from the compliance personnel, an indication of whether the transaction is valid, and storing, in the repository of historical transactions, the indication.

In some embodiments, the transaction may be related to a trading transaction, and the one or more attributes that may impact the transaction may include one or more of a stock market volatility, a crude oil value, a market index, an interest rate, a gross domestic product, a news event, and a weather event.

In some embodiments, the computing platform may train a machine learning model to determine the risk score.

These features, along with many others, are discussed in greater detail below.

### BRIEF DESCRIPTION OF THE DRAWINGS

The present disclosure is illustrated by way of example and not limited in the accompanying figures in which like reference numerals indicate similar elements and in which:

FIGS. 1A and 1B depict an illustrative computing environment for quantum computing based real-time verification system in accordance with one or more aspects described herein;

FIG. 2 depicts an illustrative architecture for quantum computing based real-time verification system in accordance with one or more aspects described herein;

FIG. 3 depicts an illustrative method for quantum computing based real-time verification system in accordance with one or more aspects described herein.

### DETAILED DESCRIPTION

In the following description of various illustrative embodiments, reference is made to the accompanying drawings, which form a part hereof, and in which is shown, by way of illustration, various embodiments in which aspects of the disclosure may be practiced. It is to be understood that other embodiments may be utilized, and structural and functional modifications may be made, without departing from the scope of the present disclosure.

It is noted that various connections between elements are discussed in the following description. It is noted that these connections are general and, unless specified otherwise, may be direct or indirect, wired or wireless, and that the specification is not intended to be limiting in this respect.

Enterprise organizations may deploy transaction processing platforms to enable users to perform transactions. Generally, it may be of high significance for an enterprise to validate and/or authorize these transactions, and to detect potentially unauthorized activity in real-time while the transaction is taking place. However, due to a large volume of such transactions, and a multitude of factors that may potentially impact each transaction, it may be a challenge for organizations to validate and/or authorize the transactions in real-time. For example, in some instances, it may take several days to validate and/or authorize these transactions. An inability to detect potentially unauthorized activity in a timely manner may pose challenges to a smooth functioning of the transaction processing platform. Accordingly, rapid detection of unauthorized activity, as well as a fast and reliable method to approve valid transactions, with speed and accuracy, may be of high significance for the enterprise organization. However, due to the large volume of transactions, and the plurality of factors that may potentially impact each transaction, classical computers may not be able to process and detect potentially unauthorized activity, and/or approve valid transactions.

Accordingly, a quantum computing system may be designed to be appropriately configured with machine learning models to perform such operations in real-time. As described herein, the quantum computing system may associate each transaction with a sequence of quantum bits, and the sequence of quantum bits may be associated with a risk score indicative of a validity of the transaction. New transactions may be converted to a sequence of quantum bits, and rapidly compared to sequence of quantum bits corresponding to past transactions. Near-instantaneous alerts may be generated to flag potentially unauthorized activity, and automatic real-time approvals may be provided for valid transactions. Entanglement in quantum computing may identify related transactions instantaneously when a transaction occurs, by verifying related historical transactions, and trade patterns modeled via machine learning algorithms.

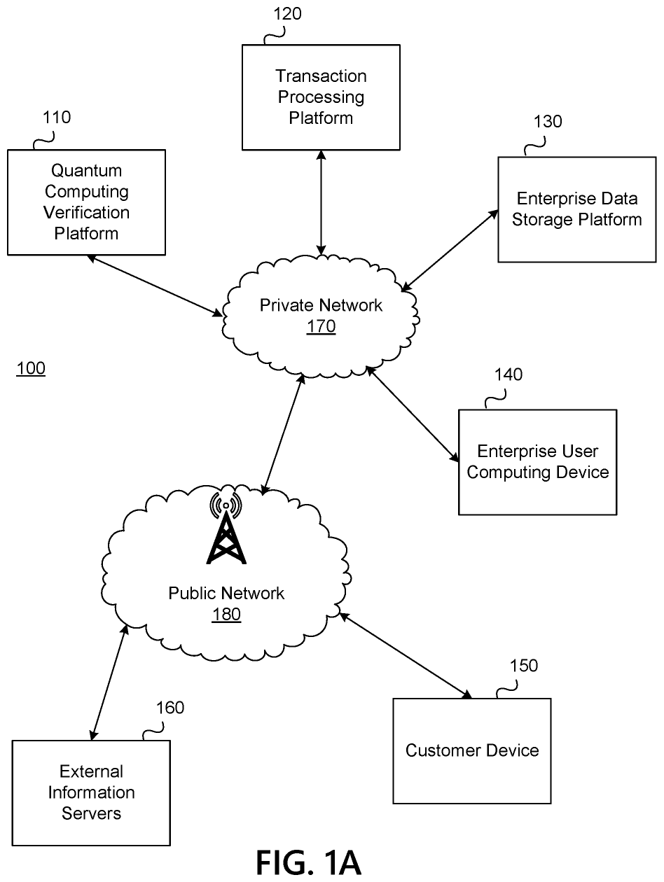

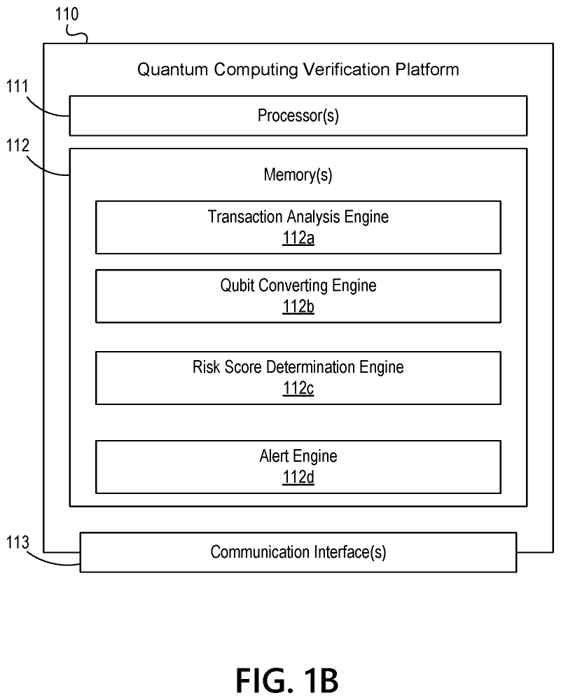

FIGS. 1A and 1B depict an illustrative computing environment for quantum computing based real-time verification system. Referring to FIG. 1A, computing environment 100 may include one or more computer systems. For example, computing environment 100 may include a quantum computing verification platform 110, a transaction processing platform 120, an enterprise data storage platform 130, an enterprise user computing device 140, a customer device 150, and external information servers 160.

As illustrated in greater detail below, quantum computing verification platform 110 may include one or more computing devices configured to perform one or more of the functions described herein. For example, quantum computing verification platform 110 may include one or more computers (e.g., laptop computers, desktop computers, servers, server blades, or the like) and/or other computer components (e.g., processors, memories, communication interfaces). In particular, quantum computing verification platform 110 may be configured to perform operations based on quantum computing, and to generate, manipulate, modify, and/or sequence of quantum bits.

Transaction processing platform 120 may include one or more computing devices and/or other computer components (e.g., processors, memories, communication interfaces). In addition, transaction processing platform 120 may be configured to host, execute, and/or otherwise provide one or more applications that enable transactions. For example, transaction processing platform 120 may be configured to host, execute, and/or otherwise provide one or more applications, such as, for example, banking applications, trading applications, mortgage applications, business loan applications, and/or other applications associated with an enterprise organization. In some instances, transaction processing platform 120 may be configured to provide various enterprise and/or back-office computing functions for an enterprise organization. For example, transaction processing platform 120 may include various servers and/or databases that process and/or otherwise maintain business information, information associated with business processes, data from a plurality of external sources, and so forth. In addition, transaction processing platform 120 may process and/or otherwise execute actions based on scripts, commands and/or other information received from other computer systems included in computing environment 100. Additionally or alternatively, transaction processing platform 120 may receive instructions from quantum computing verification platform 110 and execute the instructions in a timely manner.

Enterprise data storage platform 130 may include one or more computing devices and/or other computer components (e.g., processors, memories, communication interfaces). In addition, and as illustrated in greater detail below, enterprise data storage platform 130 may be configured to store and/or otherwise maintain information related to transactions. For example, enterprise data storage platform 130 may be configured to store and/or otherwise maintain data associated with a banking transaction, a trade related transaction, a loan transaction, and so forth. In addition, and as illustrated in greater detail below, enterprise data storage platform 130 may be configured to store and/or otherwise maintain quantum bits. Additionally or alternatively, transaction processing platform 120 may load data from enterprise data storage platform 130, manipulate and/or otherwise process such data, and return modified data and/or other data to enterprise data storage platform 130 and/or to other computer systems included in computing environment 100.

Enterprise user computing device 140 may be a personal computing device (e.g., desktop computer, laptop computer) or mobile computing device (e.g., smartphone, tablet, wearable device). In addition, enterprise user computing device 140 may be linked to and/or used by an employee of the enterprise organization that hosts quantum computing verification platform 110, perform one or more operations associated with transaction processing platform 120, such as, for example, reviewing, validating, and/or denying transactions.

Customer device 150 may be a personal computing device (e.g., desktop computer, laptop computer) or mobile computing device (e.g., smartphone, tablet, wearable device), that may be used to access transaction processing platform 120. Also, for example, user of customer device 150 may be a customer of an enterprise organization hosting quantum computing verification platform 110.

External information servers 160 may include one or more computing devices and/or other computer components (e.g., processors, memories, communication interfaces). In addition, transaction processing platform 120 may be configured to host, execute, and/or otherwise provide one or more data sources for information from LiDAR, traffic application programming interfaces (API), news feeds (e.g., social network, media network), and so forth. In some embodiments, external information servers 160 may be a personal computing device (e.g., desktop computer, laptop computer) or mobile computing device (e.g., smartphone, tablet, wearable device), that may be a source of information.

Computing environment 100 also may include one or more networks, which may interconnect one or more of quantum computing verification platform 110, transaction processing platform 120, enterprise data storage platform 130, enterprise user computing device 140, customer device 150, and/or external information servers 160. For example, computing environment 100 may include a private network 170 (which may, e.g., interconnect quantum computing verification platform 110, transaction processing platform 120, enterprise data storage platform 130, enterprise user computing device 140, and/or one or more other systems which may be associated with an organization, and public network 180 (which may, e.g., interconnect customer device 150, and/or external information servers 160 with private network 170 and/or one or more other systems, public networks, sub-networks, and/or the like). Public network 180 may be a cellular network, including a high generation cellular network, such as, for example, a 5G or higher cellular network. In some embodiments, private network 170 may likewise be a high generation cellular enterprise network, such as, for example, a 5G or higher cellular network.

In one or more arrangements, transaction processing platform 120, enterprise data storage platform 130, enterprise user computing device 140, customer device 150, and/or external information servers 160, and/or the other systems included in computing environment 100 may be any type of computing device capable of receiving input via a user interface, and communicating the received input to one or more other computing devices. For example, transaction processing platform 120, enterprise data storage platform 130, enterprise user computing device 140, customer device 150, and/or external information servers 160, and/or the other systems included in computing environment 100 may, in some instances, be and/or include server computers, desktop computers, laptop computers, tablet computers, smart phones, or the like that may include one or more processors, memories, communication interfaces, storage devices, and/or other components. As noted above, and as illustrated in greater detail below, any and/or all of quantum computing verification platform 110, transaction processing platform 120, enterprise data storage platform 130, enterprise user computing device 140, customer device 150, and/or external information servers 160, may, in some instances, be special-purpose computing devices configured to perform specific functions.

Referring to FIG. 1B, quantum computing verification platform 110 may include one or more processors 111, memory 112, and communication interface 113. A data bus may interconnect processor 111, memory 112, and communication interface 113. Communication interface 113 may be a network interface configured to support communication between quantum computing verification platform 110 and one or more networks (e.g., network 160, network 170, a local network, or the like). Memory 112 may include one or more program modules having instructions that when executed by processor 111 cause quantum computing verification platform 110 to perform one or more functions described herein and/or one or more databases that may store and/or otherwise maintain information which may be used by such program modules and/or processor 111. In some instances, the one or more program modules and/or databases may be stored by and/or maintained in different memory units of quantum computing verification platform 110 and/or by different computing devices that may form and/or otherwise make up quantum computing verification platform 110. For example, memory 112 may have, store, and/or include a transaction analysis engine 112a, a qubit converting engine 112b, a risk score determination engine 112c, and an alert engine 112d.

Transaction analysis engine 112a may have instructions that direct and/or cause quantum computing verification platform 110 to receive, by a computing device and from a transaction processing platform, one or more features of a transaction by a customer. In some embodiments, transaction analysis engine 112a may have instructions that direct and/or cause quantum computing verification platform 110 to retrieve, by the computing device and from a plurality of data sources, one or more attributes that may impact the transaction. In some embodiments, transaction analysis engine 112a may have instructions that direct and/or cause quantum computing verification platform 110 to identify, by the computing device and based on the transaction and the one or more attributes, a plurality of business rules applicable to the transaction.

Qubit converting engine 112b may have instructions that direct and/or cause quantum computing verification platform 110 to transform, by the computing device and based on the one or more features of the transaction, the one or more attributes that may impact the transaction, and the plurality of business rules applicable to the transaction, the transaction to a sequence of quantum bits.

Risk score determination engine 112c may have instructions that direct and/or cause quantum computing verification platform 110 to determine, by the computing device and for the sequence of quantum bits, a risk score indicative of a validity of the transaction.

Alert engine 112d may have instructions that direct and/or cause quantum computing verification platform 110 to determine, by the computing device and based on the risk score, whether the transaction is valid. In some embodiments, alert engine 112d may have instructions that direct and/or cause quantum computing verification platform 110 to provide, by the computing device and based on a determination that the transaction is not valid, an alert to the transaction processing platform.

Generally, an enterprise organization may deploy a transaction processing platform (e.g., transaction processing platform 120) provide services to a customer base. For example, an enterprise organization hosting transaction processing platform 120 may provide a mobile banking application. Such an application may provide a customer an ability to log in to their account, review account information, deposit checks, transfer funds, provide instructions to execute trades, review and/or utilize offers from vendors, change login credentials, update account information, and so forth.

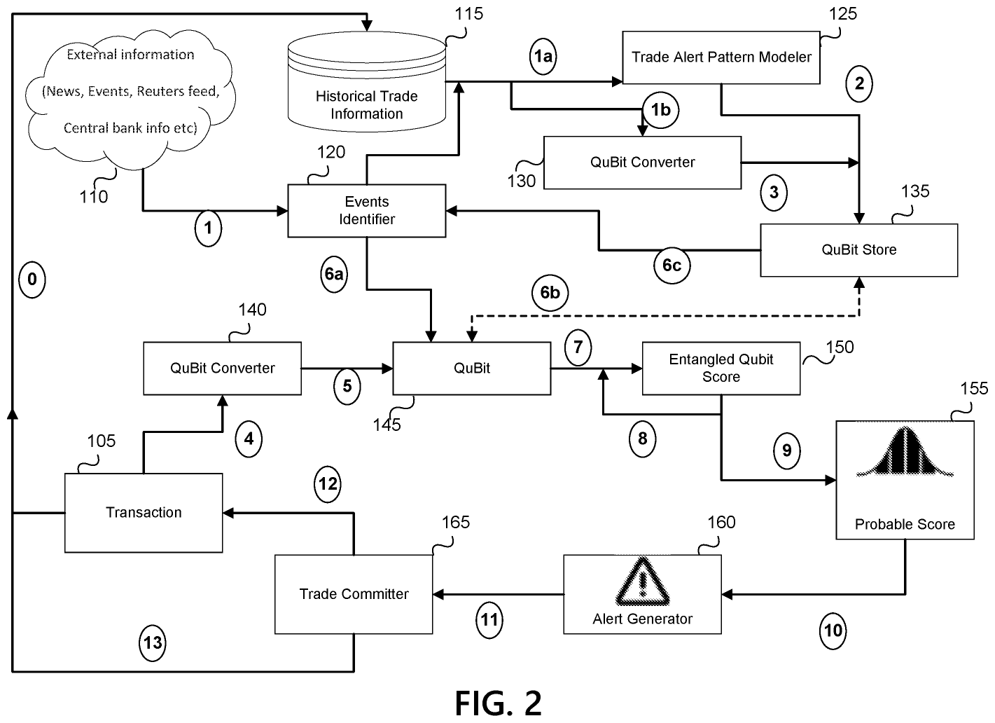

FIG. 2 depicts an illustrative architecture for quantum computing based real-time verification system. Referring to FIG. 2, at step 0, quantum computing verification platform 110 may receive, by a computing device and from a transaction processing platform, one or more features of a transaction by a customer. For example, a customer may perform a transaction 115 via customer device 150 and over a transaction processing platform (e.g., transaction processing platform 120). The transaction may be any exchange between one or more parties. For example, the transaction may be a transfer of funds, a withdrawal and/or deposit of funds, a trade related transaction (e.g., buying and selling stocks and/or derivatives over a trading platform), and so forth. The one or more features of the transaction may include a personal information of a party to the transaction (e.g., name, date of birth, account information, credit information, social security number, authentication details), a location of the transaction (e.g., a physical location such as a banking facility or an automated teller machine (ATM), an IP address for an online transaction, and so forth), a type of transaction (e.g., withdrawal, deposit, buy, sell, and so forth), a time of the transaction, a source and/or destination of the funds, legal terms of the transaction, and so forth. In some embodiments, the one or more features of the transaction may be stored in an enterprise storage platform (e.g., enterprise storage platform 130) or a database for historical trade information 115.

In some embodiments, quantum computing verification platform 110 may retrieve, by the computing device and from a plurality of data sources, one or more attributes that may impact the transaction. For example, the one or more attributes 110 may be external information such as news, events, a feed from a news agency, information from a central bank, and so forth. In some embodiments, quantum computing verification platform 110 may retrieve the one or more attributes from external servers (e.g., external information servers 160). For example, the one or more attributes may be information extracted from news feeds and/or weather related information from one or more sources. For example, sources may include one or more news servers, broadcast channels, radio networks, web-based sources of news, social media networks, blogposts, a weather channel, and so forth, and quantum computing verification platform 110 may retrieve the one or more attributes from such data sources.

For example, the transaction may be related to a trading transaction, and the one or more attributes that may impact the transaction 105 may include one or more of a stock market volatility, a crude oil value, a market index, an interest rate, a gross domestic product, a news event, and a weather event. As described herein, when the stock market is more volatile, a confidence in a trade related transaction may be low. Also, for example, when a gross domestic product for a nation is high, a confidence in a trade related transaction associated with the country, and/or a party or a business organization from the country, may be high. In some embodiments, at step 1, the one or more attributes may be provided to an events identifier 120. Generally, the events identifier 120 may process the one or more attributes and identify those that may be of relevance to the transaction 105.

In some embodiments, quantum computing verification platform 110 may identify, by the computing device and based on the transaction and the one or more attributes, a plurality of business rules applicable to the transaction. Generally, every transaction may have certain constraints and/or parameters that govern the transaction. For example, a transaction may require a physical signature, or may be authenticated by other means (e.g., biometric identifiers, electronic signatures, and so forth). As another example, the transaction may be a transfer of funds and the plurality of business rules may include a number of transfers permitted in a day, a maximum amount of a transfer, and so forth. Also, for example, the transaction may be a trading transaction, and the plurality of business rules may include a type of permissible currency, a type of stocks, a time limit, and so forth.

In some embodiments, data stored in the historical trade information 115 and an output from events identifier 120, may, at step 1a, be provided to trade alert pattern modeler 125. The trade alert pattern modeler 125 may be configured to run one or more clustering algorithms that detect patterns in data stored in the historical trade information 115 and the information received from the events identifier 120. For example, the trade alert pattern modeler 125 may be configured to run a K-means clustering algorithm to classify transactions based on such detected patterns.

In some embodiments, quantum computing verification platform 110 may transform, by the computing device and based on the one or more features of the transaction, the one or more attributes that may impact the transaction, and the plurality of business rules applicable to the transaction, the transaction to a sequence of quantum bits. For example, data stored in the historical trade information 115 may, at step 1b, be provided to qubit converter 130. The qubit converter 130 may be configured to transform the transaction to a sequence of quantum bits (qubit).

Generally, the term “quantum bit” or “qubit” as used herein, refers to a quantum version of a bit in classical computing. Like a classical bit may be in two states, “0” and “1”, a quantum bit may be in a linear combination of two orthogonal states denoted as “|0>” and “|1>.” However, when a quantum bit is measured, its physical manifestation may be in two discrete forms, that may be denoted as “|0>” and “|1>.” A qubit may be physically manifested in a variety of forms, such as, for example, polarizations of a photon, discrete energy levels of an ion, spin states of an electron, and so forth. Generally, 40 qubits may be encoded to represent approximately a trillion transactions.

Each transaction may be associated with a sequence of quantum bits. For example, the one or more features of the transaction, the one or more attributes that may impact the transaction, and the plurality of business rules applicable to the transaction, may be encoded into a sequence of quantum bits. Accordingly, when two transactions share similarities in the one or more features of the transaction, the one or more attributes that may impact the transaction, and/or the plurality of business rules applicable to the transaction, the corresponding sequences of quantum bits may be very similar. For example, for a transaction between two persons, if the type of transaction, amount of the transaction, and so forth are identical, then the corresponding sequences of quantum bits may be identical as well.

In some embodiments, quantum computing verification platform 110 may determine, by the computing device and for the sequence of quantum bits, a risk score indicative of a validity of the transaction. At step 3, the qubit sequence from qubit converter 130 may be associated with a risk score, where the risk score is based on a classification generated by the trade alert platform modeler 125, and provided to the qubit store 135 at step 2. For example, in some instances, the classification may be binary. For example, transactions may be classified as valid or invalid. Accordingly, valid transactions may be associated with a risk score of “0” and invalid transactions may be associated with a score of “1”.

In some embodiments, the risk score may be a value between 0 and 1, and where 1 may be indicative of a high likelihood that the transaction is not valid, and where 0 may be indicative of a high likelihood that the transaction is valid. For example, transactions with a risk score in a range of 0.9-1 may be associated with a high likelihood of being invalid, whereas transactions with a risk score in a range of 0-0.3 may be associated with a high likelihood of being valid. As another example, trade alert pattern modeler 125 may determine four classes for the transactions, such as for example, transactions that are highly valid, transactions that are moderately valid, transactions that are moderately invalid, and transactions that are highly invalid. Accordingly, qubit store 135 may associate qubit sequences for such transaction with risk scores. For example, transactions that are highly valid may be associated with a risk score between 0.0-0.25, transactions that are moderately valid may be associated with a risk score between 0.25-0.50, transactions that are moderately invalid may be associated with a risk score between 0.50-0.75, and transactions that are highly invalid may be associated with a risk score between 0.75-1.0.

Generally, steps 0, 1a, 1b, 2, and 3 may be performed at an initial stage for initial configuration of the system. At the completion of these steps, historical transactions may be associated with qubit sequences, and the qubit sequences may be associated with risk scores.

In some embodiments, qubit store 135 may provide, at step 6c, one or more of the qubit score, qubit sequence, detected patterns, and so forth, to the events identifier 120. The events identifier 120 may be configured to utilize this information to process the one or more attributes and identify those that may be of relevance to the transaction 105.

In some embodiments, quantum computing verification platform 110 may receive, by the computing device and from the transaction processing platform, one or more features of a second transaction by the customer. For example, a second transaction 105 between two parties may occur. Then, quantum computing verification platform 110 may transform, by the computing device and based on one or more features of the second transaction, one or more attributes that may impact the second transaction, and a plurality of business rules applicable to the second transaction, the second transaction to a second sequence of quantum bits. For example, the transaction may be provided, at step 4, to qubit converter 140. Qubit converter 140 may be configured with the same logic rules as qubit converter 130. Accordingly, qubit converter 140 may, for an input with the same underlying features, attributes, and business rules as an input to qubit converter 130, output, at step 5, the same sequence of quantum bits as qubit converter 130.

Subsequently, quantum computing verification platform 110 may match, based on a repository of historical transactions, the second sequence of quantum bits to the sequence of quantum bits. As described herein, a same set of underlying features, attributes, and business rules may result in the same sequence of quantum bits, and similar sets of underlying features, attributes, and business rules may result in similar sequences of quantum bits. Accordingly, as sequences of quantum bits are stored in qubit store 135, matching the second sequence of quantum bits to the historical sequence of quantum bits enables quantum computing verification platform 110 to determine, instantaneously, a risk profile for the second transaction, based on previously determined risk profiles of historical transactions.

For example, quantum computing verification platform 110 may associate, based on the matching, the risk score with the second sequence of quantum bits. For example, the second sequence of quantum bits may be matched with the sequence of quantum bits corresponding to a historical transaction. Based on the matching, the historical transaction has a risk profile that is the same as the second transaction. Accordingly, at step 6b, the second sequence of quantum bits may be entangled with the matched sequence of quantum bits. In some embodiments, the risk score associated with the matched sequence of quantum bits may then be associated with the second sequence of quantum bits, resulting in an entangled qubit score 150.

In some embodiments, quantum computing verification platform 110 may determine, based on the determination that the transaction is not valid, that the second transaction is not valid. Subsequently, quantum computing verification platform 110 may provide, to the transaction processing platform, a second alert that the second transaction is not valid.

As described herein, at step 6b, the second sequence of quantum bits may be entangled with the matched sequence of quantum bits. Generally the term “entanglement” as used herein refers to a high degree of correlation between two sequences of qubits. As described herein, two similar transactions may be transformed to similar sequences of quantum bits. As two sequences are entangled, they may store all possible combinations of the possible quantum states of the qubits in the sequence. Accordingly, a change in a qubit in one sequence will lead to a corresponding change in the same qubit in the second sequence. Accordingly, when the qubits are measured, their physical states would be identical. Generally, qubits may be in stable form at a temperature on 0° Kelvin. This may generally be challenging to achieve physically. Accordingly, any changes in the temperature may cause the qubits to be unstable. Accordingly, when a risk score for the sequence of qubits is determined, different physical manifestations, caused by the instability, may result in different risk scores. However, as the two sequences are entangled, both sequences may demonstrate the same changes in respective risk scores. Entanglement in quantum computing may identify related transactions instantaneously when a transaction occurs, by verifying related historical transactions, and trade patterns modeled via machine learning algorithms.

In some embodiments, quantum computing verification platform 110 may determine the risk score by determining, for the sequence of quantum bits, a plurality of risk scores, and identifying a particular risk score, of the plurality of risk scores, that has a high probability of occurrence. For example, at step 7, an entangled qubit score 150 may be determined for the second sequence of qubits, based on a risk score of a historical sequence of qubits. However, due to an instability of the qubits, at step 5, the entangled score may be iteratively determined. Several iterations may be performed, and a particular risk score with a highest probability of occurrence may be identified, and at step 9, the second sequence of quantum bits may be associated with the particular risk score or probable score 155. Generally, although steps 7 and 8 may be iteratively applied several times, a time taken may be at a scale of nanoseconds.

In some embodiments, quantum computing verification platform 110 may train a machine learning model to determine the risk score. As described herein, trade alert pattern modeler 125 may be configured to apply a machine language model to detect patterns in underlying features, attributes, and business rules for transactions. Based on such patterns, quantum computing verification platform 110 may train the machine learning model to determine risk scores. For example, certain classes of transactions may be associated with a high level of risk. For example, if an underlying attribute is associated with high volatility, the corresponding trade related transaction may be associated with a high level of risk. As another example, if an underlying business rule indicates a geographical limitation for a transaction, then a transaction outside the scope of that geographical limitation may be associated with a high level of risk. As another example, if a party to a transaction has a low credit score rating, then the transaction may be associated with a high level of risk. Quantum computing verification platform 110 may train the machine learning model to correlate patterns within the one or more features of the transaction, the one or more attributes that may impact the transaction, and the plurality of business rules applicable to the transaction, and automatically associate a risk score with a sequence of quantum bits representing the transaction. For example, if the transaction is determined to be associated with a high level of risk, the corresponding sequence of quantum bits representing the transaction may be associated with a high risk score. Also, for example, if the transaction is determined to be associated with a low level of risk, the corresponding sequence of quantum bits representing the transaction may be associated with a low risk score.

In some embodiments, quantum computing verification platform 110 may determine, by the computing device and based on the risk score, whether the transaction is valid. As described herein, historical transactions may be associated with levels of risk, and corresponding sequences of quantum bits may be associated with a risk score indicative of the level of risk. Accordingly, when a second transaction occurs, the second sequence of qubits may be matched to an existing sequence of bits, and based on an entangled qubit score 150, and/or a probable score 155, quantum computing verification platform 110 may determine whether the second transaction is valid.

In some embodiments, quantum computing verification platform 110 may determine whether the transaction is valid by comparing the risk score to a threshold, and determining that the transaction is not valid when the risk score is above the threshold. For example, transactions that are highly valid may be associated with a risk score between 0.0-0.25, transactions that are moderately valid may be associated with a risk score between 0.25-0.50, transactions that are moderately invalid may be associated with a risk score between 0.50-0.75, and transactions that are highly invalid may be associated with a risk score between 0.75-1.0. Accordingly, when the second transaction is associated with a risk score of 0.8, quantum computing verification platform 110 may identify this risk score to be greater than a threshold of 0.75, and may determine that the transaction is not valid.

In some arrangements, quantum computing verification platform 110 may determine whether the transaction is valid by determining that the risk score is within a range of ambiguity. For example, when the second transaction is associated with a risk score of 0.6, quantum computing verification platform 110 may identify this risk score to be in a range 0.50-0.75, which may indicate that the second transaction may be moderately invalid. Accordingly, in some instances, quantum computing verification platform 110 may, at step 10, generate an alert via alert generator 160, and at step 11, provide the alert to a trade committer 165 to determine the validity of the transaction. The trade committer 165 may, at step 12, determine that the second transaction is unauthorized, and may send a notification to the transaction platform to stop the second transaction 105. In some embodiments, the trade committer 165 may, at step 12, determine that the second transaction is authorized, and may send a notification to the transaction platform to approve the second transaction 105.

In some examples, quantum computing verification platform 110 may receive, via the computing device and from the trade committer 165, an indication of whether the transaction is valid, and store, in the repository of historical transactions, the indication. For example, quantum computing verification platform 110 may receive an indication that the trade committer 165 determined, at step 12, that the second transaction is unauthorized. Accordingly, at step 13, quantum computing verification platform 110 may store the indication in the database for historical trade information 115. Also, for example, quantum computing verification platform 110 may receive an indication that the trade committer 165 determined, at step 12, that the second transaction is authorized. Accordingly, at step 13, quantum computing verification platform 110 may store the indication in the database for historical trade information 115.

In some example arrangments, quantum computing verification platform 110 may train a machine learning model to verify transactions. For example, a reinforced learning model may be configured to analyze the indication stored in the database for historical trade information 115, and learn over time the types of transactions that are approved by the trade committer 165, and the types of transactions that are not approved by the trade committer 165. A reinforced machine learning model may be positively reinforced each time a transaction is approved by the trade committer 165, and the reinforced machine learning model may be negatively reinforced each time a transaction is not approved by the trade committer 165. A decision model may then be configured based on such labeled training data, and the machine learning model may be configured to automatically determine risk scores.

In some embodiments, quantum computing verification platform 110 may provide, by the computing device and based on a determination that the transaction is not valid, an alert to the transaction processing platform. For example, quantum computing verification platform 110 may provide the alert via an interactive graphical user interface. For example, alert generator 160 may provide an alert to trade committer 165 via the interactive graphical user interface. Similarly, the trade committer may provide an indication of approval of the transaction, or an indication of non-approval of the transaction, via the interactive graphical user interface.

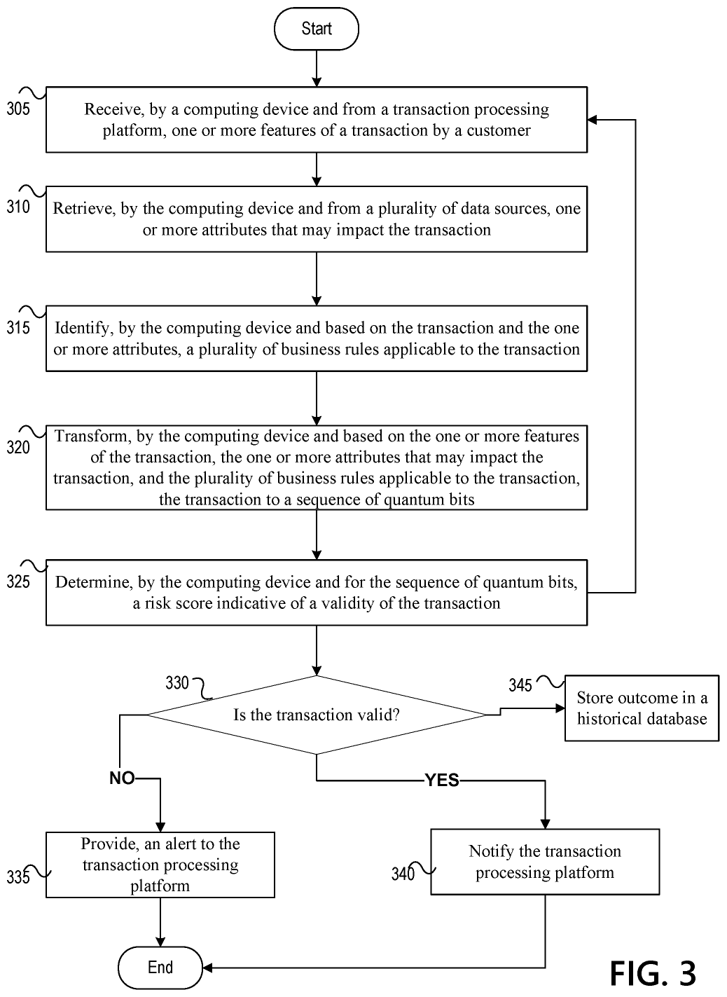

FIG. 3 depicts an illustrative method for quantum computing based real-time verification system. Referring to FIG. 3, at step 305, a quantum computing verification platform 110, having at least one processor, and memory storing computer-readable instructions that, when executed by the at least one processor, cause quantum computing verification platform 110 to receive, by a computing device and from a transaction processing platform, one or more features of a transaction by a customer. At step 310, quantum computing verification platform 110 may retrieve, by the computing device and from a plurality of data sources, one or more attributes that may impact the transaction. At step 315, quantum computing verification platform 110 may identify, by the computing device and based on the transaction and the one or more attributes, a plurality of business rules applicable to the transaction. At step 320, quantum computing verification platform 110 may transform, by the computing device and based on the one or more features of the transaction, the one or more attributes that may impact the transaction, and the plurality of business rules applicable to the transaction, the transaction to a sequence of quantum bits. At step 325, quantum computing verification platform 110 may determine, by the computing device and for the sequence of quantum bits, a risk score indicative of a validity of the transaction. In some embodiments, the process may return to step 305 to receive one or more features of a second transaction.

At step 330, quantum computing verification platform 110 may determine, by the computing device and based on the risk score, whether the transaction is valid. Upon a determination that the transaction is valid, quantum computing verification platform 110 may proceed to step 340. At step 340, quantum computing verification platform 110 may notify the transaction processing platform that the transaction is valid. Upon a determination that the transaction is not valid, quantum computing verification platform 110 may proceed to step 335. At step 335, quantum computing verification platform 110 may provide an alert to the transaction processing platform. In some embodiments, the process may proceed from step 330 to step 345. At step 345, quantum computing verification platform 110 may store the outcome of the determination at step 325 in an enterprise storage platform (e.g., a historical information database).

In some embodiments, quantum computing verification platform 110 may train a machine learning model to verify transactions. For example, a reinforced learning model may be configured to store the one or more features of the transaction, the one or more attributes that may impact the transaction, and the plurality of business rules applicable to the transaction. The reinforced learning model may be positively reinforced each time the process moves to step 440, and the reinforced learning model may be negatively reinforced each time the process moves to step 435. A decision model may then be configured based on such labeled training data.

One or more aspects of the disclosure may be embodied in computer-usable data or computer-executable instructions, such as in one or more program modules, executed by one or more computers or other devices to perform the operations described herein. Generally, program modules include routines, programs, objects, components, data structures, and the like that perform particular time-sensitive tasks or implement particular abstract data types when executed by one or more processors in a computer or other data processing device. The computer-executable instructions may be stored as computer-readable instructions on a computer-readable medium such as a hard disk, optical disk, removable storage media, solid-state memory, RAM, and the like. The functionality of the program modules may be combined or distributed as desired in various embodiments. In addition, the functionality may be embodied in whole or in part in firmware or hardware equivalents, such as integrated circuits, application-specific integrated circuits (ASICs), field programmable gate arrays (FPGA), and the like. Particular data structures may be used to more effectively implement one or more aspects of the disclosure, and such data structures are contemplated to be within the scope of computer executable instructions and computer-usable data described herein.

Various aspects described herein may be embodied as a method, an apparatus, or as one or more computer-readable media storing computer-executable instructions. Accordingly, those aspects may take the form of an entirely hardware embodiment, an entirely software embodiment, an entirely firmware embodiment, or an embodiment combining software, hardware, and firmware aspects in any combination. In addition, various signals representing data or events as described herein may be transferred between a source and a destination in the form of light or electromagnetic waves traveling through signal-conducting media such as metal wires, optical fibers, or wireless transmission media (e.g., air or space). In general, the one or more computer-readable media may be and/or include one or more non-transitory computer-readable media.

As described herein, the various methods and acts may be operative across one or more computing servers and one or more networks. The functionality may be distributed in any manner, or may be located in a single computing device (e.g., a server, a client computer, and the like). For example, in alternative embodiments, one or more of the computing platforms discussed above may be combined into a single computing platform, and the various functions of each computing platform may be performed by the single computing platform. In such arrangements, any and/or all of the above-discussed communications between computing platforms may correspond to data being accessed, moved, modified, updated, and/or otherwise used by the single computing platform. Additionally or alternatively, one or more of the computing platforms discussed above may be implemented in one or more virtual machines that are provided by one or more physical computing devices. In such arrangements, the various functions of each computing platform may be performed by the one or more virtual machines, and any and/or all of the above-discussed communications between computing platforms may correspond to data being accessed, moved, modified, updated, and/or otherwise used by the one or more virtual machines.

Aspects of the disclosure have been described in terms of illustrative embodiments thereof. Numerous other embodiments, modifications, and variations within the scope and spirit of the appended claims will occur to persons of ordinary skill in the art from a review of this disclosure. For example, one or more of the steps depicted in the illustrative figures may be performed in other than the recited order, and one or more depicted steps may be optional in accordance with aspects of the disclosure.

What is claimed is:

1. A computing platform, comprising:
at least one processor; and
memory storing computer-readable instructions that, when executed by the at least one processor, cause the computing platform to:
receive, by a computing device and from a transaction processing platform, one or more features of a transaction by a customer;
retrieve, by the computing device and from a plurality of data sources, one or more attributes that may impact the transaction;
identify, by the computing device and based on the transaction and the one or more attributes, a plurality of business rules applicable to the transaction;
transform, by the computing device and based on the one or more features of the transaction, the one or more attributes that may impact the transaction, and the plurality of business rules applicable to the transaction, the transaction to a sequence of quantum bits;
determine, by the computing device and for the sequence of quantum bits, a risk score indicative of a validity of the transaction;
determine, by the computing device and based on the risk score, whether the transaction is valid; and
provide, by the computing device and based on a determination that the transaction is not valid, an alert to the transaction processing platform.

2. The computing platform of claim 1, wherein the instructions comprise additional computer-readable instructions that, when executed by the at least one processor, cause the computing platform to:
receive, by the computing device and from the transaction processing platform, one or more features of a second transaction by the customer;
transform, by the computing device and based on one or more features of the second transaction, one or more attributes that may impact the second transaction, and a plurality of business rules applicable to the second transaction, the second transaction to a second sequence of quantum bits;
match, based on a repository of historical transactions, the second sequence of quantum bits to the sequence of quantum bits;
associate, based on the matching, the risk score with the second sequence of quantum bits;
determine, based on the determination that the transaction is not valid, that the second transaction is not valid; and
provide, to the transaction processing platform, a second alert that the second transaction is not valid.

3. The computing platform of claim 1, wherein the risk score is a value between 0 and 1, and wherein 1 is indicative of a high likelihood that the transaction is not valid, and wherein 0 is indicative of a high likelihood that the transaction is valid.

4. The computing platform of claim 1, wherein the instructions comprise additional computer-readable instructions that, when executed by the at least one processor, cause the computing platform to determine the risk score by:
determining, for the sequence of quantum bits, a plurality of risk scores; and
identifying a particular risk score, of the plurality of risk scores, that has a high probability of occurrence.

5. The computing platform of claim 1, wherein the instructions comprise additional computer-readable instructions that, when executed by the at least one processor, cause the computing platform to determine whether the transaction is valid by:
comparing the risk score to a threshold; and
determining that the transaction is valid when the risk score is below the threshold.

6. The computing platform of claim 1, wherein the instructions comprise additional computer-readable instructions that, when executed by the at least one processor, cause the computing platform to determine whether the transaction is valid by:
comparing the risk score to a threshold; and
determining that the transaction is not valid when the risk score is above the threshold.

7. The computing platform of claim 1, wherein the instructions comprise additional computer-readable instructions that, when executed by the at least one processor, cause the computing platform to determine whether the transaction is valid by:
determining that the risk score is within a range of ambiguity;
providing an alert to a compliance personnel to determine the validity of the transaction;
receiving, via the computing device and from the compliance personnel, an indication of whether the transaction is valid; and
storing, in a repository of historical transactions, the indication.

8. The computing platform of claim 1, wherein the transaction is related to a trading transaction, and the one or more attributes that may impact the transaction comprise one or more of a stock market volatility, a crude oil value, a market index, an interest rate, a gross domestic product, a news event, and a weather event.

9. The computing platform of claim 1, wherein the instructions comprise additional computer-readable instructions that, when executed by the at least one processor, cause the computing platform to:
train a machine learning model to determine the risk score.

10. A method, comprising:
at a computing platform comprising at least one processor, and memory:
receiving, by a computing device and from a transaction processing platform, one or more features of a transaction by a customer;
retrieving, by the computing device and from a plurality of data sources, one or more attributes that may impact the transaction;
identifying, by the computing device and based on the transaction and the one or more attributes, a plurality of business rules applicable to the transaction;
transforming, by the computing device and based on the one or more features of the transaction, the one or more attributes that may impact the transaction, and the plurality of business rules applicable to the transaction, the transaction to a sequence of quantum bits;
determining, for the sequence of quantum bits and based on a machine learning model, a risk score indicative of a validity of the transaction;
determining, by the computing device and based on the risk score, whether the transaction is valid; and
providing, by the computing device and based on a determination that the transaction is not valid, an alert to the transaction processing platform.

11. The method of claim 10, further comprising:
receiving, by the computing device and from the transaction processing platform, one or more features of a second transaction by the customer;
transforming, by the computing device and based on one or more features of the second transaction, one or more attributes that may impact the second transaction, and a plurality of business rules applicable to the second transaction, the second transaction to a second sequence of sequence of quantum bits;
matching, based on a repository of historical transactions, the second sequence of quantum bits to the sequence of quantum bits;
associating, based on the matching, the risk score with the second sequence of quantum bits;
determining, based on the determination that the transaction is not valid, that the second transaction is not valid; and
providing, to the transaction processing platform, a second alert that the second transaction is not valid.

12. The method of claim 10, further comprising:
associating, by the computing device and with the sequence of quantum bits, the risk score; and
storing, by the computing device and in a repository of historical transactions, the association between the sequence of quantum bits and the risk score.

13. The method of claim 10, wherein the risk score is a value between 0 and 1, and wherein 1 is indicative of a high likelihood that the transaction is not valid, and wherein 0 is indicative of a high likelihood that the transaction is valid.

14. The method of claim 10, further comprising:
determining, for the sequence of quantum bits, a plurality of risk scores; and
identifying a particular risk score, of the plurality of risk scores, that has a high probability of occurrence.

15. The method of claim 10, further comprising:
comparing the risk score to a threshold; and
determining that the transaction is valid when the risk score is below the threshold.

16. The method of claim 10, further comprising:
comparing the risk score to a threshold; and
determining that the transaction is not valid when the risk score is above the threshold.

17. The method of claim 10, further comprising:
determining that the risk score is within a range of ambiguity;
providing an alert to a compliance personnel to determine the validity of the transaction;
receiving, via the computing device and from the compliance personnel, an indication of whether the transaction is valid; and
storing, in a repository of historical transactions, the indication.

18. The method of claim 10, wherein the transaction is related to a trading transaction, and the one or more attributes that may impact the transaction comprise one or more of a stock market volatility, a crude oil value, a market index, an interest rate, a gross domestic product, a news event, and a weather event.

19. The method of claim 10, further comprising:
training a machine learning model to determine the risk score.

20. One or more non-transitory computer-readable media storing instructions that, when executed by a computing platform comprising at least one processor, and memory, cause the computing platform to:
receive, by a computing device and from a transaction processing platform, one or more features of a transaction by a customer;
retrieve, from a plurality of data sources, one or more attributes that may impact the transaction;
identify, based on the transaction and the one or more attributes, a plurality of business rules applicable to the transaction;
transform, by the computing device and based on the one or more features of the transaction, the one or more attributes that may impact the transaction, and the plurality of business rules applicable to the transaction, the transaction to a sequence of quantum bits;
identify, based on a repository of historical transactions, a second sequence of quantum bits similar to the sequence of quantum bits, wherein the second sequence of quantum bits represents a previous transaction;
retrieve, from the repository of historical transactions, a risk score associated with the second sequence of quantum bits, wherein the risk score is indicative of a validity of the previous transaction;
associate, with the sequence of quantum bits, the retrieved risk score;
determine, based on the retrieved risk score, whether the transaction is valid; and
provide, based on a determination that the transaction is not valid, an alert to the transaction processing platform.
